(19) United States
(12) Patent Application Publication
(10) Pub. No.: US 2007/0168184 A1
(43) Pub. Date: Jul. 19, 2007

(54) METHOD AND SYSTEM FOR MANAGING MESSAGE DISTRIBUTIONS IN MULTI-MESSAGING SYSTEM

(75) Inventors: CHUNG-I LEE, Taipei Hsien (TW); CHIEN-FA YEH, Taipei Hsien (TW); XIAO-PING ZHANG, Shenzhen (CN); XIAO-DI FAN, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/556,178

(22) Filed: Nov. 3, 2006

(30) Foreign Application Priority Data
Jan. 12, 2006 (CN) 200610032907.1

(51) Int. Cl. G10L 19/02; G10L 21/00

(52) U.S. Cl. 704/204

(57) ABSTRACT

A system for managing message distributions in multi-messaging system includes a server, at least one messaging request system and at least one messaging delivery system connected to the server. The server includes a message managing module which is programmed for receiving at least one messaging request from the at least one messaging request system, creating a message assignment for each messaging request, and sending each massage assignment to a corresponding massage receiving system. A related method is also disclosed. Utilizing the system and method can manage and maintain system messages in an unified way.

### BACKGROUND OF THE INVENTION

1. Field of the Invention

The present invention relates to systems and methods for managing messages, and more particularly to a system and method for managing message distributions in multi-messaging system.

2. General Background

Messages can be used for communication between people and systems, messaging systems such as Electronic Mail, Instant Messaging service, Short Messaging Service, and Multimedia Messaging Service all have their own data formats, data headers, data transmitting protocols, etc. As the quantity of messaging request systems increases, the application of these messages will be very complex in that the way of sending message, the manner of the message, the form of the content will be difference by different people and increase message business.

Generally speaking, designers design and maintain a message managing system targeted at a specific messaging request system. With the increase of messaging request, the form of sending message become more complex, and the work quantity of maintaining a system became more and more. Especially when the quantity of different messaging request system became more and more, the work of managing and maintaining the system became more complex.

What is needed, therefore, is a system for managing message distributions in multi-messaging system, which can manage and maintain system messages in an unified way.

Similarly, what is also needed is a method for managing message distributions in multi-messaging system, which can manage and maintain system messages in an unified way.

### SUMMARY

A system for managing message distributions in multi-messaging system includes a server, at least one messaging request system and at least one messaging delivery system connected to the server. The server includes a message managing module which is programmed for receiving at least one messaging request from the at least one messaging request system, creating a message assignment for each messaging request, and sending each massage assignment to a corresponding massage receiving system.

A method for managing message distributions in multi-messaging system includes the steps of: receiving at least one messaging request from at least one messaging request system, and adding the at least one messaging request to a message-to-send queue, each messaging request comprising a message type identifier and Extensible Markup Language message data; detecting a messaging service and a position of Extensible Stylesheet Language Transformation for each messaging request according to the message type identifier in the messaging request; creating a message assignment for each messaging request by converting the Extensible Markup Language data of the messaging request via the Extensible Stylesheet Language Transformation; sending each message assignment to a corresponding messaging delivery system according to the messaging service.

Other advantages and novel features of the present invention will become more apparent from the following detailed description of preferred embodiments when taken in conjunction with the accompanying drawings.

### BRIEF DESCRIPTION OF THE DRAWINGS

FIG. 1 is a schematic diagram of hardware configuration of a system for managing message distributions in multi-messaging system in accordance with a preferred embodiment;

FIG. 2 is a schematic diagram of main function unit of a massage managing module of FIG. 1;

FIG. 3 is a flowchart of a method for sending a messaging request by utilizing the system of FIG. 1; and

FIG. 4 is a flowchart of a preferred method for managing message distributions in multi-messaging system in accordance with a preferred embodiment.

### DETAILED DESCRIPTION OF THE INVENTION

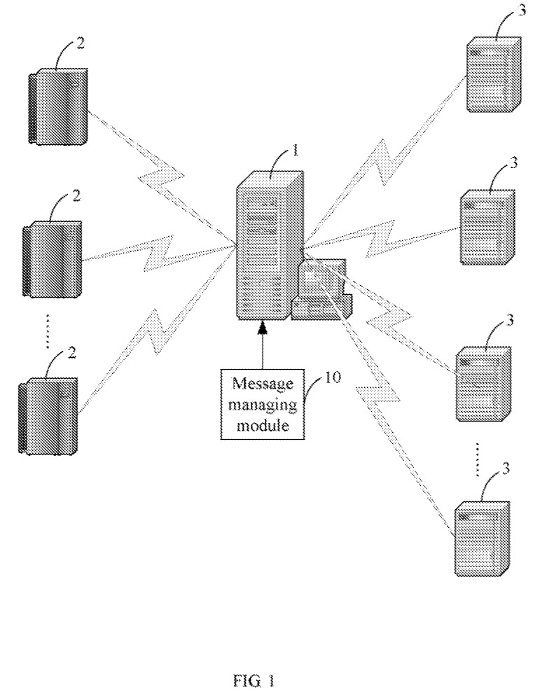

FIG. 1 is a schematic diagram of hardware configuration of a system for managing message distributions in multi-messaging system (hereinafter, “the system”) in accordance with a preferred embodiment of the present invention. The system includes a plurality of messaging request systems 2 (only three shown) for sending messaging requests, a plurality of messaging delivery systems 3 (only four shown) for delivering messaging assignments, and a server 1 linked with the messaging request systems 2 and the messaging delivery systems 3, for receiving the messaging requests from the messaging request systems 2 and sending the messaging assignments to the messaging delivery systems 3 correspondingly. The server 1 includes a message managing module 10, for managing the message distributions between the messaging request systems 2 and the messaging delivery systems 3. The messaging delivery systems 3 may be mail messages delivery systems, instant messages delivery systems, short messages delivery systems, or any other messages delivery systems.

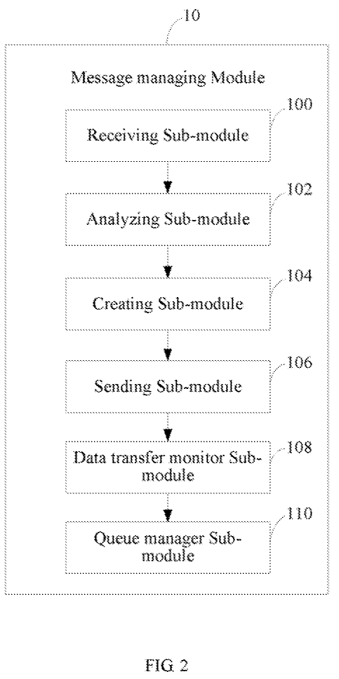

FIG. 2 is a schematic diagram of main function units of the message managing module 10. The message managing module 10 typically includes a receiving sub-module 100, an analyzing sub-module 102, a creating sub-module 104, a sending sub-module 106, a data transfer monitor sub-module 1 08, and a queue manager sub-module 11 0.

The receiving sub-module 100 is programmed for receiving messaging requests from the messaging request systems 2 and adding the messaging requests to a message-to-send queue. Each of the messaging requests includes message data and a message type identifier. The message data may be in an extensible markup language (XML) format. The message type identifier corresponds to a messaging service of messaging request that can be distributed to a messaging request system 2 before the messaging request system 2 send messaging request.

The analyzing sub-module 102 is programmed for detecting the messaging service and a location of an extensible stylesheet language transformation (XSLT) for the messaging request according to the message type identifier in the messaging request. The messaging service may be the mail message messaging service, the instant message messaging service, the short message messaging service, or any other message messaging service according to the type of the messaging request received by receiving sub-module 100.

The creating sub-module 104 is programmed for creating a message assignment for each messaging request, including a message topic and corresponding message contents obtained by converting the message data that is formatted in XML via the XSLT.

The sending sub-module 106 is programmed for sending each message assignment created by the creating sub-module 104 to the messaging delivery systems 3 correspondingly. The message assignment is an XML formatted message satisfying standards specified by the messaging service.

The data transfer monitor sub-module 108 is programmed for detecting whether each message assignment sent from the sending sub-module 106 has been delivered successfully by the messaging delivery systems 3 correspondingly.

The queue manager sub-module 110 is programmed for moving the messaging request from the message-to-send queue to a message messagesent list corresponding the message assignment that has been delivered by the messaging receiving system 3 successfully, and for moving the messaging request from the message-to-send queue to an error list corresponding the message assignment that has not been delivered by the messaging receiving system 3 successfully.

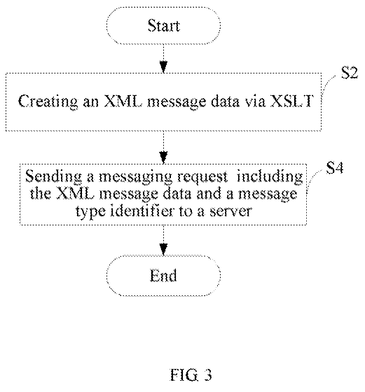

FIG. 3 is a flowchart of a method for sending the messaging request by utilizing the system of FIG. 1. In step S2, the messaging request system 2 creates an XML message data via XSLT. The XML and the XSLT must have the same attributes. For example, if the XSLT have the sentence:

<![CDATA[Honorific<font color=‘#ff0000’>]]><xsl: value-of select=“//PayLoadBody /MessageContent/InCharge”/><![CDATA[</font>sir/miss]]>the XML must have the corresponding sentence:

<PayloadBody><MessageContent><InCharge>jack</InCharge></MessageContent></Payload Body>.

The converted sentence would be

“Honorific <font color=‘#ff0000’>jack</font>sir/miss”

In step S4, the sending sub-module 106 sends the messaging request including the XML message data and a message type identifier in the messaging request to the server1.

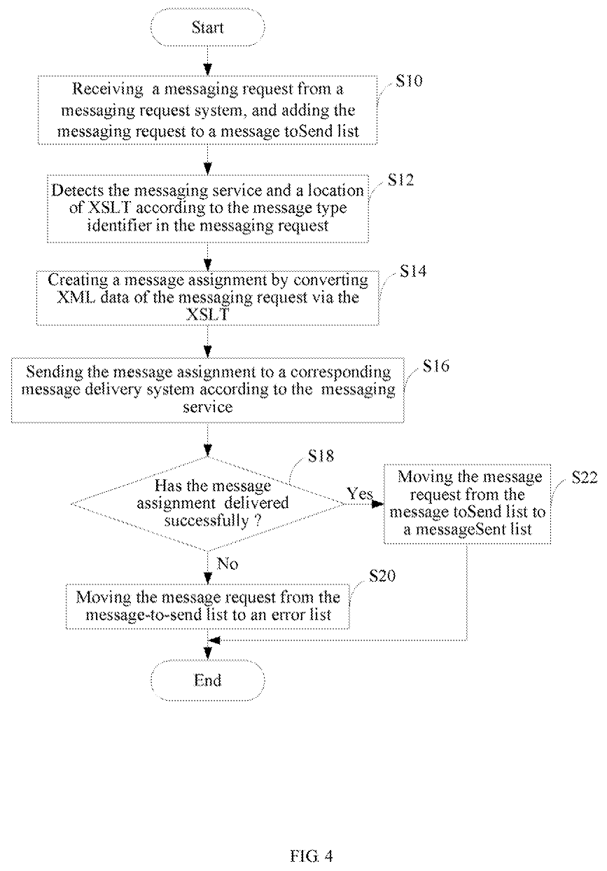

FIG. 4 is a flowchart of a preferred method for managing message distributions in multi-messaging system in accordance with a preferred embodiment. In step SI 0, the receiving sub-module 100 receives the messaging request from the messaging request system 2, and adds the messaging request to the message-to-send queue.

In step 12, the analyzing sub-module 102 detects the messaging service and a location of the XSLT according to the message type identifier in the messaging request.

In step S14, the creating sub-module 104 creates the message assignment by converting XML data of the messaging request via the XSLT.

In step S16, the sending sub-module 106 sends the message assignment to the messaging delivery systems 3 according to the messaging service.

In step S18, the data transfer monitor sub-module 108 detects whether the message assignment has been delivered successfully.

If the message assignment has not been delivered successfully, in step S20; the queue manager sub-module 110 moves the messaging request from the message-to-send queue to the error list.

Otherwise, if the message assignment has been delivered successfully, in step S22, the queue manager sub-module 110 moves the messaging request from the message-to-send queue to the message messageSent list.

Although the present invention has been specifically described on the basis of a preferred embodiment and a preferred method, the invention is not to be construed as being limited thereto. Various converts or modifications may be made to said embodiment and method without departing from the scope and spirit of the invention.

What is claimed is:

1. A system for managing message distributions in multi-messaging system comprising a server, at least one messaging request system and at least one messaging delivery system connected to the server, the server comprising a message managing module configured for receiving at least one messaging request from the at least one messaging request system, creating a message assignment for each messaging request, and sending each massage assignment to a corresponding massage receiving system.

2. The system as claimed in claim 1, wherein the messaging request includes Extensible Markup Language message data and a message type identifier.

3. The system as claimed in claim 2, wherein the message managing module comprises:
a receiving sub-module for receiving the at least one messaging request from the at least one messaging request system, and adding the at least one messaging request to a message-to-send queue;
an analyzing sub-module for detecting a messaging service and a position of Extensible Stylesheet Language Transformation for each messaging request according to the message type identifier in the messaging request;
a creating sub-module for creating a message assignment for each messaging request by converting the Extensible Markup Language data of the messaging request via the Extensible Stylesheet Language Transformation; and
a sending sub-module for sending each message assignment to a corresponding messaging delivery system according to the messaging service of the message assignment.

4. The system as claimed in claim 3, wherein the message managing module further comprises:
a data transfer monitor sub-module for detecting whether the message assignment has been delivered successfully;
a queue manager sub-module for moving the messaging request from the message-to-send queue to a message messageSent list if the message assignment has been delivered successfully, and for moving the messaging request from the message-to-send queue to an error list if the message assignment has not been delivered successfully.

5. A computer-based method for managing message distributions in multi-messaging system, the method comprising the steps of:
receiving at least one messaging request from at least one messaging request system, and adding the at least one messaging request to a message-to-send queue, each messaging request comprising a message type identifier and Extensible Markup Language message data;
detecting a messaging service and a position of Extensible Stylesheet Language Transformation for each messaging request according to the message type identifier in the messaging request;
creating a message assignment for each messaging request by converting the Extensible Markup Language data of the messaging request via the Extensible Stylesheet Language Transformation; and
sending each message assignment to a corresponding messaging delivery system according to the messaging service.

6. The method as claimed in claim 5, further comprising the steps of:
detecting whether the message assignment has been delivered successfully;
moving the messaging request from the message-to-send queue to a message messageSent list if the message assignment has been delivered successfully; and
moving the messaging request from the message-to-send queue to an error list if the message assignment has not been delivered successfully.
